(19) United States
(12) Patent Application Publication
(10) Pub. No.: US 2004/0134875 A1
(43) Pub. Date: Jul. 15, 2004

(54) Circuit-parts sheet and method of producing a multi-layer circuit board

(75) Inventors: Norimitsu Fukami, Kokubu (JP); Shuichi Tateno, Kokubu (JP); Seiichiro Hirahara, Kokubu (JP); Akira Imoto, Kokubu (JP)

Correspondence Address: HOGAN & HARTSON L.L.P., 500 S. GRAND AVENUE, SUITE 1900, LOS ANGELES, CA, 90071-2611, US

(73) Assignee: KYOCERA CORPORATION

(21) Appl. No.: 10/719,897

(22) Filed: Nov. 21, 2003

(30) Foreign Application Priority Data
Nov. 22, 2002 (JP) 2002-339922
Nov. 28, 2002 (JP) 2002-346079
Nov. 28, 2002 (JP) 2002-346080
Dec. 25, 2002 (JP) 2002-373994
Dec. 25, 2002 (JP) 2002-373995

(51) Int. Cl. H01B 13/00

(52) U.S. Cl. 216/13

(57) ABSTRACT

A method of producing a circuit-parts sheet having a structure in which a light-nontransmitting circuit-forming pattern is secured in a photo-cured ceramic sheet and is exposed on both surfaces of said photo-cured ceramic sheet, comprising the steps of:

(a) forming the light-nontransmitting conductor pattern on the surface of a light-transmitting film;

(b) forming a photo-curable ceramic coating layer by applying a photo-curable slurry onto the surface of the film on which said conductor pattern is formed;

(c) forming a photo-cured ceramic sheet by photo-curing said photo-curable ceramic coating layer by the irradiation with light from the back surface of said film;

(d) removing uncured portions of said photo-curable ceramic coating layer by using a developing solution; and

(e) peeling off said carrier film.

Use of this circuit-parts sheet makes it possible to produce a multi-layer circuit board simultaneously satisfying both the requirement for decreasing the thickness of the insulating layers and the requirement of increasing the thickness of the wiring conductor layers.

### BACKGROUND OF THE INVENTION

1. Field of the Invention

The present invention relates to a method of producing a circuit-parts sheet and a method of producing a multi-layer circuit board by using the above circuit-parts sheet. More specifically, the invention relates to a method of producing a thin multi-layer circuit board made of ceramics, which can be particularly effectively used for mobile communication equipment such as portable telephones.

2. Description of the Related Art

In recent years, electronic equipment have been produced in ever small sizes, ever decreased weights and in a form suited for being carried, and circuit blocks used for them have also been produced in small sizes and in a form of composite modules, urging the need to produce laminated layer parts such as ceramic multi-layer circuit boards in a highly densely fabricated form and in small sizes.

The ceramic multi-layer circuit boards have heretofore been produced by a production method called green sheet method. The green sheet method consists of preparing a green sheet that works as an insulating layer by using a slurry containing a ceramic powder relying upon a doctor blade method or the like method, laminating a plurality of pieces of the green sheets one upon the other, and firing a laminate thereof at one time to thereby produce a multi-layer circuit board. That is, through-holes are formed in each green sheet that is to be laminated at predetermined positions relying upon an NC punch or a metal mold, and are filled with a conducting paste to form via-hole conductors. On the surfaces of the green sheets, further, a conductor pattern (that serves as a surface of the multi-layer circuit board or as an internal wiring conductor layer) is printed by using a conducting paste.

Even by employing the above green sheet method, it is desired to decrease the thickness of the insulating layers among the wiring conductor layers to meet the requirement for highly precisely and highly densely fabricating the wiring conductor layers. As for the wiring conductor layers, it has been urged to increase the thickness to decrease the loss as well as to decrease the resistance.

According to the conventional production method such as the green sheet method, however, if it is attempted to simultaneously satisfy the two requirements of decreasing the thickness of the insulating layer and increasing the thickness of the wiring conductor layer, there inevitably develops a level-difference (step) equal to the thickness of the wiring conductor layer between a portion where the wiring conductor layer is formed and a portion where it is not formed.

The level-difference causes the occurrence of defective lamination (delamination). Even if it is attempted to forcibly pressurize the laminate of before being fired to offset the level-difference, a difference in the density occurs partly in the insulating layer causing deformation after the firing. Therefore, limitation is imposed on simultaneously satisfying the requirements of decreasing the thickness of the insulating layer and increasing the thickness of the wiring conductor layer.

In order to form vertical conductors such as via conductors, further, it is indispensable to perforate the through holes in the green sheet by punching or the like method; i.e., working step is necessary in addition to the printing step of forming the wiring conductor layer.

A method of suppressing the formation of level-difference caused by the thickness of the wiring conductor layer has been proposed in Japanese Unexamined Patent Publication (Kokai) No. 9-181450. According to this method, a slurry of a photo-curable ceramic material is applied onto a carrier film to form an insulating layer which is then exposed to light through a predetermined mask and is developed to form openings in the insulating layer at predetermined positions, and the openings are filled with a conducting paste through a predetermined screen thereby to form via-conductors and wiring conductor layers. Namely, according to this method, formation of an insulating layer of photo-curable ceramics, exposure to light, developing and filling of the conducting paste are repeated on the surface of the insulating layer in which the via-conductors are formed, thereby to fabricate a multi-layer wiring substrate without level-difference caused by the conductor.

According to the method of the above Japanese Unexamined Patent Publication (Kokai) No. 9-181450, however, the circuit must be formed successively for each of the insulating layers. Namely, very many steps must be executed for forming the circuits. It is not allowed to execute the steps simultaneously in parallel and, hence, extended periods of time are required for the production. In filling the openings with the conducting paste, further, a predetermined screen and the openings must be brought into position maintaining precision. In filling the openings with the conducting paste, further, the paste is not sufficiently filled in small holes such as via-holes or in the through-holes for forming patterns having narrow widths, and cavities which are the gaps tend to be formed in the paste in the through-holes.

### SUMMARY OF THE INVENTION

It is, therefore, an object of the present invention to provide a method of producing a circuit-parts sheet eliminating the above-mentioned problems inherent in the prior art, simultaneously satisfying both the requirements of decreasing the thickness of the insulating layer and increasing the thickness of the wiring conductor layer, simplifying and shortening the step of forming the conductor pattern layer, and suppressing the occurrence of cavities in the conductor pattern layer, as well as to provide a method of producing a multi-layer circuit board by using the above circuit-parts sheet.

According to the present invention, there is provided a method of producing a circuit-parts sheet having a structure in which a circuit-forming pattern having light-nontransmitting is secured in a photo-cured ceramic sheet and is exposed on both surfaces of the photo-cured ceramic sheet, comprising the steps of:

(a) forming the circuit-forming pattern having light-nontransmitting on a surface of a carrier film having light-transmitting property;

(b) forming a photo-curable ceramic coating layer having a thickness not smaller than the thickness of said circuit-forming pattern and in which said circuit-forming pattern is buried, by applying a photo-curable slurry containing an electrically insulating ceramic material on the surface of the carrier film on which said circuit-forming pattern is formed;

(c) forming a photo-cured ceramic sheet by photo-curing said photo-curable ceramic coating layer by the irradiation with light from the back surface of said carrier film;

(d) removing uncured portions of said photo-curable ceramic coating layer by using a developing solution; and

(e) peeling off said carrier film.

According to the present invention, there is further provided a method of producing a multi-layer circuit board (first method) comprising the steps of:

(f) laminating a plurality of pieces of the circuit-parts sheets obtained by the above method; and

(g) firing the laminate thereof.

According to the present invention, there is further provided a method of producing a multi-layer circuit board (second method) by preparing a circuit-parts sheet which comprises a photo-cured ceramic sheet and a circuit-forming pattern secured to said sheet and having light-transmitting property through the steps (a) to (d) described above and, then, conducting the following steps (h) to (k) of:

(h) preparing a plurality of pieces of the circuit-parts sheets with the carrier film obtained through the step (d);

(i) laminating another circuit-parts sheet with the carrier film on one circuit-parts sheet with the carrier film in a manner that the circuit-parts sheets are opposed to each other, and peeling off the carrier film from the other circuit-parts sheet;

(j) fabricating a laminate having a plurality of pieces of the circuit-parts sheets by repeating the step (i); and

(k) peeling off the carrier film from said one circuit-parts sheet of the obtained laminate, followed by firing.

According to the present invention, there is further provided a method of producing a multi-layer circuit board (third method) by preparing a circuit-parts sheet which comprises a photo-cured ceramic sheet and a circuit-forming pattern secured to said sheet and is held on the surface of a carrier film having light-transmitting property through the steps (a) to (d) described above and, then, laminating a ceramic green sheet having through-holes filled with a conducting paste on said circuit-parts sheet, peeling off the carrier film from the obtained laminate, followed by firing.

According to the method of producing a circuit-parts sheet of the present invention, it is allowed to form the light-nontransmitting circuit-forming pattern and the photo-cured ceramic sheet (that serves as the insulating layer of the multi-layer circuit board) maintaining substantially the same thickness, so that both surfaces of the circuit-forming pattern are substantially in flush with both surfaces of the photo-cured ceramic sheet. When a multi-layer circuit board is produced by using the above circuit-parts sheet, therefore, no level-difference (step) results from the thickness of the circuit-forming pattern itself, no delamination occurs, no deformation is caused by forcible pressing of the laminate prior to the firing, and it is made possible to simultaneously accomplish the requirements of decreasing the thickness of the ceramic insulating layer and increasing the thickness of the wiring conductor layer. Besides, since the via-conductors and the wiring conductor layers can be formed by printing a generally used conducting paste, there is formed no cavity (gap) due to defective filling of paste in the through-holes unlike that of the prior art.

According to the present invention, further, the circuit-forming pattern is made of an insulating ceramic material to form the portions except the conductors such as capacitors in the circuit. Thus, the multi-layer circuit board having such parts, too, can be formed in the same manner as described above.

Further, the cured ceramic sheet that serves as the insulating layer is formed by using the circuit-forming pattern as a mask, and there is no need of forming a particular mask. Besides, since the insulating layers can be formed simultaneously in parallel, the cost of production can be decreased, and a circuit-parts sheet can be produced in which the circuit-forming pattern (conductor pattern) and the ceramic sheet are integrally formed maintaining good reproduceability.

According to the method of producing a multi-layer circuit board using the above circuit-parts sheet, further, there can be formed not only a plane conducting pattern but also a three-dimensional circuit structure in which the via-conductors and the planar conductor patterns are integrated together, without the need of forming through-holes or via-conductors by filling the conducting paste that was so far necessary. Accordingly, occurrence of cavities (gaps) in the via-conductors is reliably prevented, too.

According to the present invention, further, the circuit-forming pattern and a thermally extinguishing pattern (made of, for example, a thermally disintegrating resin composition) are so formed in the step (a) that the circuit-forming pattern and the thermally extinguishing pattern not be overlapped one upon the other, and the photo-curable ceramic coating layer is so formed in the step (b) that the circuit-forming pattern and the thermally extinguishing pattern are buried therein, making it easy to form, in the multi-layer circuit board, the gaps for accommodating a variety of electric devices.

### BRIEF DESCRIPTION OF THE DRAWINGS

FIG. 1 is a view illustrating a general structure of a multi-layer circuit board produced according to the present invention, wherein FIG. 1a is a perspective view schematically illustrating a multi-layer circuit board produced according to a method of the present invention, FIG. 1b is a sectional view schematically illustrating a circuit-parts sheet used for the production of the multi-layer circuit board, and FIG. 1c is a sectional view schematically illustrating the multi-layer circuit board;

FIG. 2 is a view of steps illustrating a method of forming the circuit-parts sheet;

FIG. 3 is a view of steps illustrating a method of producing the multi-layer circuit board by using the above circuit-parts sheet;

FIG. 4 is a view of steps illustrating a method of producing the multi-layer circuit board by using the above circuit-parts sheet;

FIG. 5 is a sectional view schematically illustrating another multi-layer circuit board produced by the method of the present invention;

FIG. 6 is a sectional view schematically illustrating a circuit-parts sheet used for the production of the multi-layer circuit board of FIG. 5;

FIG. 7 is a sectional view schematically illustrating a further multi-layer circuit board produced by the method of the present invention;

FIG. 8 is a sectional view schematically illustrating a circuit-parts sheet used for the production of the multi-layer circuit board of FIG. 7; and

FIG. 9 is a view illustrating a further method of producing the multi-layer circuit board by using the circuit-parts sheet produced by the present invention.

### DETAILED DESCRIPTION OF THE INVENTION

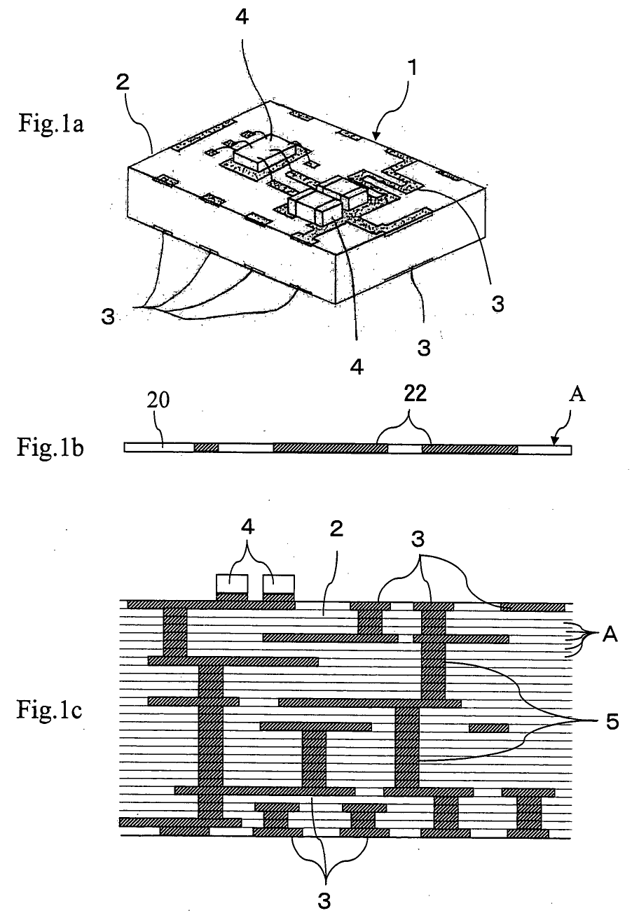

FIG. 1 is a view illustrating a general structure of a multi-layer circuit board produced according to the present invention, wherein FIG. 1a is a perspective view schematically illustrating a multi-layer circuit board, FIG. 1b is a sectional view of a circuit-parts sheet that serves as an insulating layer in the multi-layer circuit board, and FIG. 1c is a sectional view schematically illustrating the multi-layer circuit board.

In FIGS. 1a to 1c, a multi-layer circuit board generally designated at 1 has a structure in which wiring conductor layers 3 which are plane conductors are formed on the front surface, on the back surface and inside of an insulating substrate 2 made of a ceramic sintered body. Chip parts such as ICs, inductors, resistors and capacitors are mounted by soldering on the wiring conductor layer 3 formed on the surface of the insulating substrate 2, and the wiring conductor layer 3 on the back surface works as terminal electrodes for mounting on a mother board or the like.

The insulating substrate 2 is a laminate of a plurality of circuit-parts sheets A. In the insulating substrate 2 are formed via-conductors 5 for connecting together the wiring conductor layers 3 that form the plane conductors.

Referring to FIG. 1b, the circuit-parts sheet A has a structure in which a circuit-forming pattern 22 is formed in a portion of a ceramic sheet 20 containing at least a ceramic insulating material. The circuit-forming pattern 22 becomes a conductor pattern of a shape corresponding to the wiring conductor layer 3 and to the via-conductors 5 depending upon the position of the circuit-parts sheet A. Both surfaces of the circuit-forming pattern 22 are substantially in flush with both surfaces of the ceramic sheet 20. Upon firing a laminate of such circuit-parts sheets A, there is produced the multi-layer circuit board 1. Namely, the circuit-forming patterns 22 extending in the direction of a plane in the ceramic sheets 20 form wiring conductor layers 3 that serve as plane circuits, and the circuit-forming patterns extending in the direction of lamination due to the overlapping of the ceramic sheets 20 form via-conductors 5.

The ceramic sheet 20 and the circuit-forming pattern (conductor pattern) 22 are both formed as thin layers having a thicknesses of 10 to 50 μm, particularly, 15 to 40 μm and, more particularly, 15 to 30 μm. Usually, a difference in the thickness between the ceramic sheet 20 and the circuit-forming pattern 22 is not larger than 5 μm and, preferably, not larger than 3 μm, to thereby substantially suppress a level-difference between the thickness of the circuit-forming pattern 22 itself which is the conductor pattern and the thickness of the ceramic sheet 20.

In order to form a desired circuit, the multi-layer circuit board 1 is formed by laminating the circuit-parts sheets A in a number of 10 to 300 layers, particularly, 30 to 200 layers and, more particularly, 40 to 100 layers.

In the above multi-layer circuit board, the ceramic sheet 20 in the circuit-parts sheet A constituting the insulating substrate 2 is formed by using at least one kind of ceramic insulating material selected from the group consisting of:

(1) a ceramic material containing Al₂O₃, AlN, Si₃N₄ or SiC as a chief component and having a sintering temperature of not lower than 1100° C.;

(2) a ceramic material comprising a mixture of alkaline earth metal oxides such as BaO, CaO, SrO and MgO, and a metal oxide containing SiO₂, and having a sintering temperature of not higher than 1100° C. and, particularly, not higher than 1050° C.; and

(3) a low-temperature sintered ceramic material (glass ceramic material) comprising a glass powder or a mixture of a glass powder and a ceramic filler powder, and sintered at not higher than 1100° C. and, particularly, not higher than 1050° C.

As the mixture of metal oxides in the ceramic material (2) or as the glass in the glass ceramic material (3), there can be exemplified an SiO₂—BaOAl₂O₃ system, an SiO₂—B₂O₃ system, an SiO₂—B₂O₃—Al₂O₃ system, an SiO₂—Al₂O₃-alkali metal oxide system, or compositions of the systems thereof blended with an alkali metal oxide, ZnO, PbO, Pb, ZrO₂ or TiO₂. As the ceramic filler in the glass ceramic material (3), there can be exemplified at least the one selected from the group consisting of Al₂O₃, SiO₂, an alkaline earth oxide, forsterite, cordierite, mullite, AlN, Si₃N₄, SiC, MgTiO₃, CaTiO₃, diopside, spinel, gahnite and anorthite. The ceramic filler is desirably mixed at a ratio of 20 to 80 mass % with respect to the glass.

The circuit-forming pattern 22 forming the wiring conductor layers 3 and via-conductors 5 contains a suitable conducting material depending upon the temperature for firing the ceramic material that is used for forming the sheet 20. In the case of the ceramic material (1), for example, there is preferably used a conducting material containing at least one selected from the group consisting of tungsten, molybdenum and manganese, as a chief component. In order to lower the resistance, further, the conducting material may be a mixture with copper. In the case of the ceramic material (2), there is preferably used a conducting material containing at least one selected from the group consisting of copper, silver, gold and aluminum, as a chief component. It is desired that this conducting material contains a component that constitutes a ceramic material from the standpoint of cofiring with the ceramic material.

(Production of a Circuit-Parts Sheet)

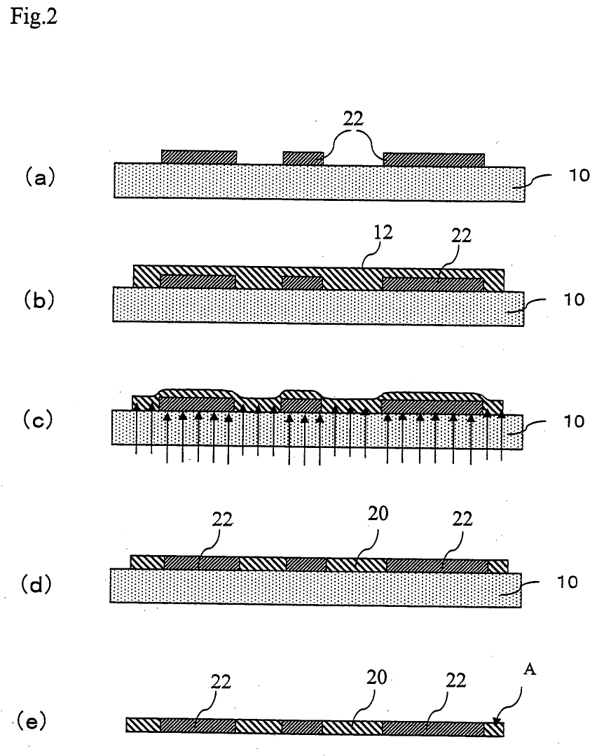

In the present invention, the circuit-parts sheet used for the production of the multi-layer circuit board 1 is produced through the steps (a) to (e) illustrated in FIG. 2.

Step (a):

First, a light-nontransmitting circuit-forming pattern 22 (corresponds to the conductor pattern formed by the wiring conductor layer 3 and via-conductors 5) is formed on the surface of the carrier film 10 having light-transmitting property.

There is no particular limitation on the carrier film 10 so far as it has light-transmitting property, and there can be used a variety of resin films. Generally, however, there is preferably used a polyester film such as of polyethylene terephthalate from the standpoint of transparency, resistance against chemicals and softness. It is desired that the carrier film 10 has a thickness of, usually, from about 30 to about 100 μm.

The circuit-forming pattern 22 must be light-nontransmitting since it is utilized as a mask at the time of exposure to light for forming the ceramic sheet 20 in the step described below (therefore, this condition is inevitably satisfied when the circuit-forming pattern 22 is used as the conducting pattern).

The circuit-forming pattern 22 can be formed in a predetermined pattern by printing or by being applied onto, for example, the carrier film 10 by a general method of printing a conducting paste, such as screen-printing method, gravure printing method or intaglio printing method. The conducting paste is prepared by mixing, as required, a ceramic material into a powder of the above-mentioned conducting material (having an average particle size of about 1 to about 3 μm), adding an organic binder such as ethyl cellulose or acrylic resin thereto, further mixing a solvent thereto, such as dibutyl phthalate, α-terpineol, butyl carbitol, or 2,2,4-trimethyl-3,3-pentadiol monoisobutylate, and homogeneously kneading the mixture using a three-roll mill. In this case, it is desired that the amount of the conducting material powder in the conducting paste is not smaller than 95 mass % calculated as a solid component. Besides, the pattern 22 can be formed by photo-lithograph method using a photosensitive electroconductive paste, too.

It is also allowable to use the circuit-forming pattern 22 by using a metal foil. That is, the metal foil of the above-mentioned conducting material is stuck onto the carrier film 10 by using, as required, a suitable sticking agent, applying a photoresist onto the metal foil, exposing it to light through a predetermined mask, and conducting the developing and etching thereby to obtain a circuit-forming pattern. Obtaining the circuit-forming pattern by using the metal foil is most desired from the standpoint of suppressing the occurrence of cavities in the pattern, since there is used neither a binder nor a solvent.

The metal foil used here is desirably the one formed by an electrolytic plating method, the one surface being a mat surface having a surface roughness Rz (JIS B 0601) of not smaller than 2 μm and the other surface being a shiny surface having a surface roughness Rz of not larger than 1 μm. To form the wiring conductor layer 3 on the surface of the multi-layer circuit board, in particular, it is desired that the shiny surface is adhered onto the carrier film 10 such that the mat surface finally faces the inside of the board. To form the internal wiring conductor layer 3, further, the mat surface is adhered onto the carrier film 10 and, after the pattern is formed, the shiny surface is roughened such that the surface roughness Rz becomes not smaller than 2 μm. This makes it possible to enhance the adhesion between the insulating layer (ceramic sheet 20) and the circuit-forming pattern 22 formed by the metal foil.

Step (b):

Referring next to FIG. 2(b), a photo-curable ceramic coating layer 12 is formed by applying a photo-curable slurry containing the above-mentioned insulating ceramic material onto the surface of the carrier film 10 on which the circuit-forming pattern 22 has been formed. The photo-curable ceramic coating layer 12 is for forming the ceramic sheet 20. In order to adjust the thickness of the ceramic sheet 20, the photo-curable slurry is applied onto the whole surface of the carrier film 10 in such an amount that the thickness when dried becomes larger than the thickness of the circuit-forming pattern 22 and that the circuit-forming pattern 22 is buried therein. The application is carried out by using, for example, a doctor blade or the like.

The photo-curable slurry contains a photo-curable component in addition to the above insulating ceramic material that is for forming the ceramic sheet 20, and is prepared by, for example, mixing an ceramic insulating powder, a photo-curable monomer (further, a photopolymerization initiator, as required), an organic binder and a plasticizer in an organic solvent, and kneading the mixture by using a ball mill.

It is desired that the photo-curable monomer has excellent thermally disintegrating property for being adapted to the step of firing at a low temperature for a short period of time. The photo-curable monomer must be photo-polymerized after drying by being exposed to light, and is desirably the one capable of forming free radicals, undergoing chain propagation addition polymerization, and having secondary carbon or tertiary carbon. Concrete examples thereof include (meth)acrylate monomers such as methyl(meth)acrylate, diglycidyl(meth)acrylate, 2-cyanomethyl (meth)acrylate, butyl(meth)acrylate, polyethylene glycol mono(meth)acrylate, allyl(meth)acrylate, 2-hydroxyethyl mono(meth)acrylate, ethylene glycol di(meth)acrylate, diethylene glycol di(meth)acrylate, triethylene glycol di(meth)acrylate, nonaethylene glycol di(meth)acrylate, propylene glycol di(meth)acrylate, dipropylene glycol di(meth)acrylate, 2,2-bis[4-(meth)acryloyloxyethoxyphenyl]propane, 2,2-bis[4-(meth)acryloyloxyethoxyethoxyphenyl]propane, 2,2-bis{4-[3-(meth)acryloyloxy-2-hydroxypropoxy]phenyl} propane, 1,4-butanediol di(meth)acrylate, 1,3-hexanediol di(meth)acrylate, urethane di(meth)acrylate, trimethylolpropane di(meth)acrylate, and polyoxyethylated trimethololpropane tri(meth)acrylate; fumaric acid ester monomers such as monomethyl fumarate, diethyl fumarate, and diphenyl fumarate; styrenes or α-methyl styrenes such as styrene, divinyl benzene, α-methylstyrene and α-methylstyrene dimeter; and allyl compounds such as diallyl phthalate, diallyl terephthalate, diallyl carbonate and allyl diglycol carbonate.

As the photopolymerization initiators, there can be exemplified benzoin alkyl ethers such as benzoinmethyl ether, benzoinethyl ether and benzoinpropyl ether; α-diketones such as camphor quinone and benzyl; and acylphosphone oxides such as 2,4,6-trimethylbenzoyldiphenylphosphine oxide, bis(2,6-dimethoxybenzoyl)-2,4,4-trimethylpentylphosphine oxide and bis(2,4,6-trimethylbenzoyl)phenylphosphine oxide.

It is desired that the organic binder is the one that thermally disintegrates favorably like the photo-curable monomer and is, preferably, an ethylenically unsaturated compound having a carboxyl group or alcoholic hydroxyl group, such as acrylic acid or methacrylic acid polymer by taking the wettability with the solid component into consideration.

The plasticizer may be a dioctyl phthalate that is widely known without any particular limitation.

The organic solvent is preferably at least one selected from the group consisting of ethylcarbitol acetate, butyl cellosolve, and 3-methoxybutyl acetate.

The contents of the components in the photo-curable slurry are such that the photo-curable monomer and the photopolymerization initiator are in amounts of 5 to 20 parts by mass, the organic binder is in an amount of 10 to 40 parts by mass, the plasticizer is in an amount of 1 to 5 parts by mass and the organic solvent is in an amount of 50 to 100 parts by mass per 100 parts by mass of the ceramic powder.

Step (c):

After the photo-curable ceramic coating layer 12 is formed as described above, the solvent is removed by drying, and the carrier film 10 is irradiated with light from the back surface thereof to photo-cure the photo-curable ceramic coating layer (hereinafter often called coating layer) 12. At the time of exposure to light (light-exposure), the light-nontransmitting circuit-forming pattern 22 works as a mask. On the circuit-forming pattern 22, therefore, the coating layer 12 is not photo-cured and forms portions that dissolve in a developing solution that will be described later. On the portions where the circuit-forming pattern 22 is not formed, the coating layer 12 is photo-cured to form portions that do not dissolve in the developing solution. As a source of light for exposure to light, there is preferably used, for example, a super-high pressure mercury lamp.

In the region where the circuit-forming pattern 22 is not formed, the thickness of the non-dissolving portion (cured portion) can be adjusted by the condition for light-exposure such as the intensity of light or the distance of light. If the non-dissolving portion is formed in a whole of the region in which the pattern 22 is not formed, the thickness of the coating layer 12 should be adjusted so that the thickness after cured is same as that of the pattern 12.

Step (d):

After exposed to light as described above, the non-cured portion (dissolving portion) of the coating layer 12 is removed by a developing treatment by using the developing solution, whereby the ceramic sheet 20 is formed, and the circuit-parts sheet A having the circuit-forming pattern 22 secured in the sheet 20 is obtained in a form of being held by the carrier film 10.

As the developing solution, there can be used the one that is widely known, such as a triethanolamine aqueous solution, and the developing treatment is conducted by spraying the developing solution followed by washing and drying.

When the photo-curing is effected by adjusting the conditions of light-exposure as described above, the curing proceeds most quickly in the portion of the coating layer 12 on the side of the carrier film 10, and, though the unreacted monomer is not almost contained, the curing proceeds slowly on the surface side of the coating layer 12 and the amount of the unreacted monomer increases. When the unreacted monomer is removed by the developing treatment, therefore, the surface of the obtained ceramic sheet 20 becomes rough. The present invention utilizes the roughened surface of the ceramic sheet 20 to increase the adhering strength of the laminate as will be described later.

From the standpoint of increasing the adhering strength, the surface roughness Rmax (JIS B 0601) is, usually, not smaller than 1 μm, particularly, not smaller than 2 μm and, most particularly, not smaller than 3 μm. The surface roughness can be adjusted relying upon the concentration of the developing solution.

Step (e):

After the developing treatment is conducted as described above, the carrier film 10 is peeled off to obtain the circuit-parts sheet A that can be used for the production of the multi-layer circuit board 1 described above.

In the circuit-parts sheet A, the ceramic sheet 20 and the circuit-forming pattern 22 have substantially the same thickness as the thickness of the sheet 20 is adjusted by adjusting the coating amount of the coating layer or the conditions of light-exposure as described above. That is, the difference of thickness between the sheet 20 and the circuit-forming pattern 22 (conductor pattern) is not larger than 5 μm and, preferably, not larger than 3 μm, whereby the level-difference between the two is substantially suppressed, and the surfaces are substantially in flush between the two.

(Production of a Multi-Layer Circuit Board)

In the present invention, a multi-layer circuit board having a circuit structure as shown in FIGS. 1a to 1c is fabricated by using the circuit-parts sheet A produced as described above.

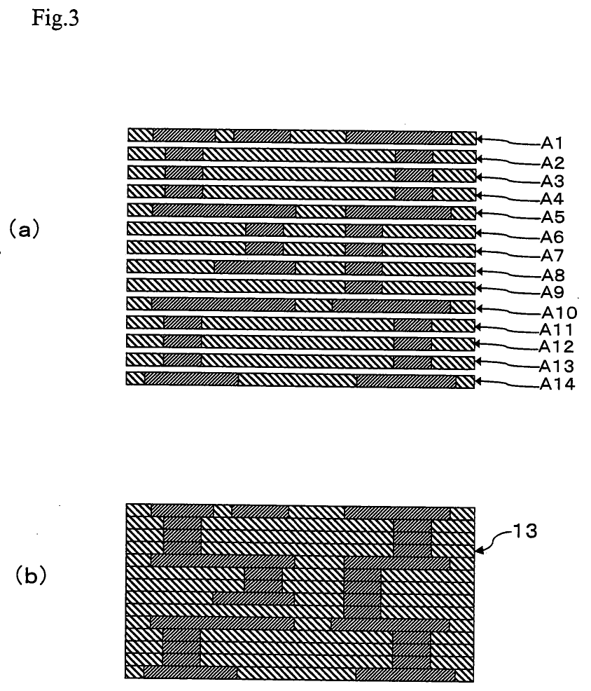

FIG. 3 illustrates a process for producing the multi-layer circuit board.

In the production of FIG. 3, circuit-parts sheets A1 to A14 having a predetermined circuit-forming pattern (conductor pattern) are prepared through the above-mentioned steps (a) to (e), overlapped one upon the other while placing them in position (see FIG. 3(a)), and are, then, pressed-adhered at one time to obtain a laminate 13 (see FIG. 3(b)).

It is desired that the press-adhesion is conducted while elevating the temperature to be not lower than a glass-transition point of the organic binder contained in the circuit-parts sheets A. The press-adhesion can also be effected by applying an organic adhesive among the circuit-parts sheets A.

In laminating at one time, the carrier films 10 may have been peeled off from all of the circuit-parts sheets A. By taking into consideration the handling of the lowermost surface and the uppermost surface at the time of press-adhesion, however, the circuit-parts sheets A14 and A1 on the lowermost surface and on the uppermost surface of the laminate 13 are used in a form having the carrier films 10 which may, then, be peeled off after the lamination and press-adhesion.

In overlapping the circuit-parts sheets A, further, it is desired that the overlapping surfaces on one side of the cured ceramic sheets have been roughened as described above. Namely, when the press-adhesion is effected, the ceramic component and conducting component in the circuit-parts sheets A enter into the dents in the rough surface to exhibit an anchoring function. As a result, the laminate 13 exhibits an increased adhering strength.

The thus produced laminate 13 is fired at a predetermined temperature to obtain a multi-layer circuit board 1 in which is formed a three-dimensional circuit owing to the linking of the circuit-forming patterns 22 (conductor patterns).

Prior to the firing, the organic binder and the photo-curable monomer contained in the laminate 13 are extinguished through the step of removing the binder. The firing is conducted in an inert atmosphere such as of nitrogen or in the atmosphere at a temperature high enough for firing the ceramic material and the conducting material that are used, to accomplish a relative density of not lower than 95%.

After the firing, the surface of the obtained substrate is, as required, subjected to the surface treatment such as printing/baking or electroplating of a thick resistance film and a thick protection film. Then, electronic parts 4 inclusive of IC chips are joined to fabricate a multi-layer circuit board which is a final product.

The wiring conductor layer on the surface of the multi-layer circuit board 1 (insulating substrate 2) can be formed on the surface of the fired laminate by being printed, dried and baked in a predetermined atmosphere. In order to improve wettability to the solder, further, nickel or gold is plated in a thickness of 1 to 3 μm on the surfaces of the wiring conductor layer 3 on the surface and on the surfaces of the terminal electrodes (wiring conductor layer 3 on the lower surface).

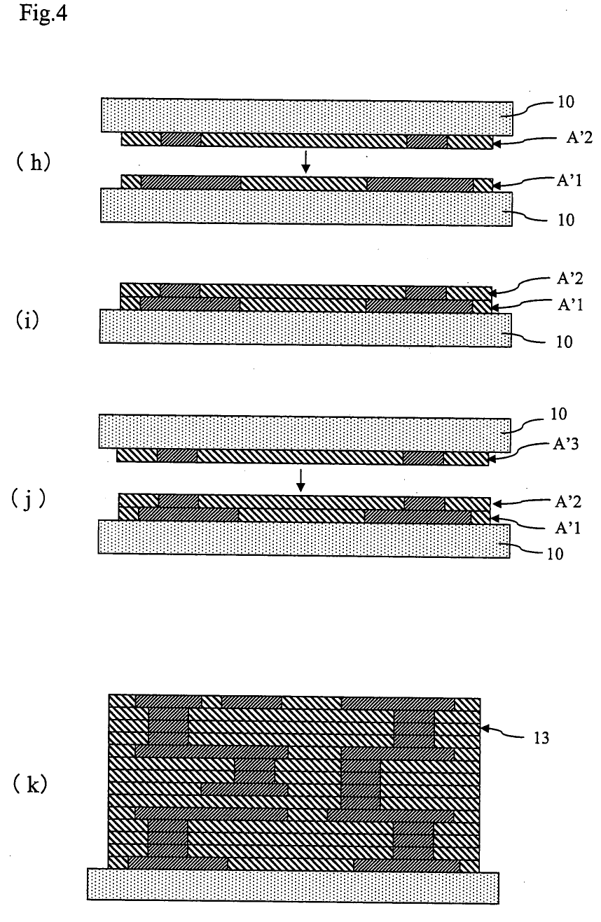

The above-mentioned example of production is the case of using the circuit-parts sheets A obtained through the step (e) of FIG. 2. The circuit-parts sheets A can be used for producing the multi-layer circuit board without peeling off the carrier films 10. Namely, the circuit-parts sheets A with film obtained in the step (d) of FIG. 2 can be directly used for producing the multi-layer circuit board. To produce the multi-layer circuit board by using the circuit-parts sheets A with film, a laminate is fabricated through the steps (h) to (k) illustrated in FIG. 4.

Step (h):

There are prepared a plurality of pieces of circuit-parts sheets A with the carrier film 10 obtained through the above-mentioned step (d).

Step (i):

Then, another circuit-parts sheet A′2 with the carrier film is laminated on the one circuit-parts sheet A′1 with the carrier film in a manner that the circuit-parts sheets are faced to each other (step i-1) and, then, the carrier film 10 is peeled off from the other circuit-parts sheet A′2 (step i-2).

Step (j)

The above step (i) is repeated to successively laminate the circuit-parts sheet A′3,—to fabricate a laminate.

Step (k):

The carrier film 10 is peeled off from the one circuit-parts sheet A′1 of the thus obtained laminate 13, followed by firing to obtain the multi-circuit board in the same manner as the production of FIG. 3 described above.

The multi-circuit board after firing is subjected to the surface treatment of the board and to the junction of electronic parts 4 in the same manner as in the production of FIG. 3 to obtain a final product.

The foregoing description has dealt with the production of a multi-layer circuit board by using the circuit-parts sheets of the present invention, the light-nontransmitting circuit-forming pattern 22 being the conductor pattern formed by the wiring conductor layer 3 and the via-conductor 5. However, the circuit-forming pattern 22 may be the one other than the conductor pattern. Namely, the circuit may incorporate functional parts having a nonconducting portion, such as capacitors and inductors, in addition to the wiring conductors. According to the present invention, patterns of such functional parts may also be incorporated in the circuit-forming pattern 22.

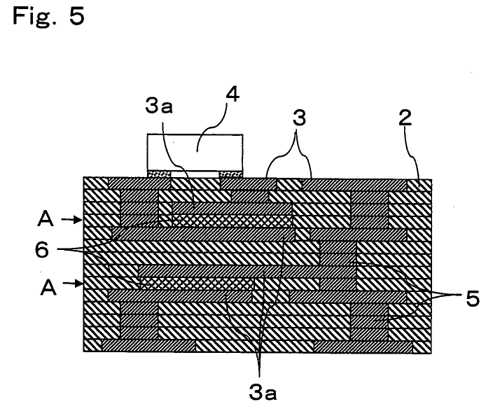

FIG. 5 illustrates, in cross section, another structure of the multi-layer circuit board that can be produced by the method of the present invention. Namely, the multi-layer circuit board 1 of FIG. 5 is the same as the multi-layer circuit board of FIG. 1 in the basic structure, but is different from the multi-layer circuit board of FIG. 1 in regard to that a functional ceramic layer 6 is formed in the insulating substrate 2. Namely, the functional ceramic layer 6 is made of a functional ceramic material depending upon the functions, and may, for example, be a ceramic layer of a low dielectric constant, a ceramic layer of a high dielectric constant, or a magnetic ceramic layer. When the functional ceramic layer 6 is a ceramic layer of a high dielectric constant, a capacitor is formed by the wiring conductor layers 3a extending up and down and by the functional ceramic layer 6.

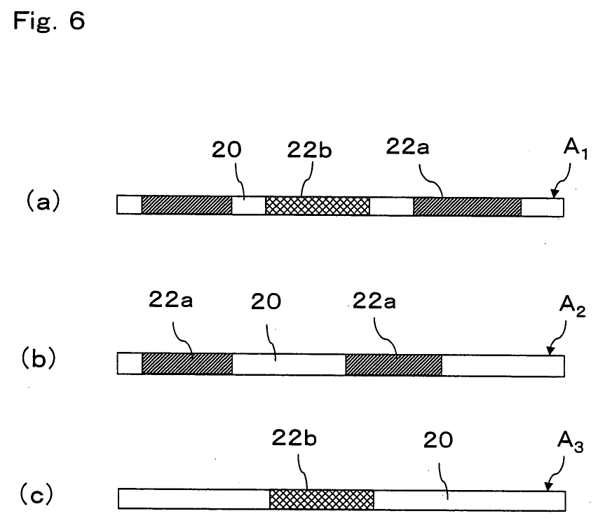

To form the multi-layer circuit board 1 having the above-mentioned circuit structure as shown in FIG. 6, there are used a circuit-parts sheet A1 having a circuit-forming pattern 22a (hereinafter called conductor pattern) that serves as a conductor pattern and a circuit-forming pattern 22b (hereinafter called functional pattern) that serves as a functional ceramic layer 6, that are formed in the ceramic sheet 20 (FIG. 6(a)), and a circuit-parts sheet A₂ having the conductor pattern 22a only formed in the ceramic sheet 20 (FIG. 6(b)). Depending upon the circuit structure, further, there can be used a circuit-parts sheet A₃ of a structure having the functional pattern 22b only formed in the ceramic sheet 20 (FIG. 6(c)).

The above-mentioned circuit-parts sheet having the functional pattern 22b can be fabricated through the above-mentioned steps of FIGS. 2(a) to 2(e) with the exception of using a ceramic paste containing a material for forming the functional ceramic layer 6 and forming the functional pattern 22b on the carrier film 10. By using this circuit-parts sheet, too, it is allowed to decrease the thickness of the functional pattern 22b like that of the conductor pattern 22a, to effectively suppress the step between the functional pattern 22b and the ceramic sheet 20, and, to produce the multi-layer circuit board 1 of the structure shown in FIG. 5 through the same steps as those described above.

To form the functional ceramic layer 6, it is desired that the ceramic sheet 20 for forming the insulating board and the functional ceramic layer 6 are both made of glass ceramic materials that can be fired at low temperatures of not higher than 1100° C. and, particularly, not higher than 1050° C., so that they can be cofired. In this case, the functional ceramic layer 6 is made of a glass ceramic material having a composition different from that of the ceramic sheet 20. The functional ceramic layer 6 having a low dielectric constant is made of, for example, a glass ceramic material containing at least one kind of filler having a low dielectric constant selected from the group consisting of a glass of a low dielectric constant, silica, cordierite and enstatite. The functional ceramic layer 6 having a high dielectric constant is made of a glass ceramic material containing, as a filler, a titanate such as BaTiO₃ or LaTiO₃. Further, the functional ceramic layer 6 having a magnetic property is made of a glass ceramic material containing at least an element of the iron group. A ceramic paste prepared by mixing the above glass ceramic material together with an organic binder and an organic solvent, is applied onto the carrier film 10 in a predetermined pattern to form the functional pattern 22b. The circuit-parts sheet is prepared by the same method as the one described earlier to produce the multi-layer circuit board.

According to the method of the present invention, further, the ceramic sheet 20 is provided with a thermally extinguishing pattern together with the light-nontransmitting circuit-forming pattern to easily fabricate a multi-layer circuit board accommodating various electronic parts in the recessed portions.

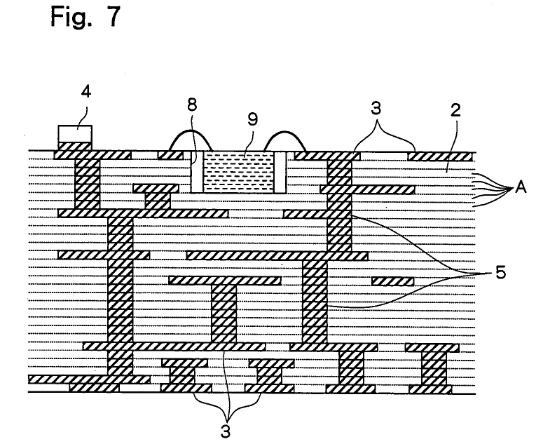

FIG. 7 illustrates, in cross section, a further structure of the multi-layer circuit board that can be produced by the method of the present invention. Namely, the multi-layer circuit board of FIG. 7 is the same as the multi-layer circuit board 1 of FIG. 1 in the basic structure, but is different from the multi-layer circuit board 1 of FIG. 1 with regard to that recessed portions 8 are formed in the surface of the insulating substrate 2 and that electronic parts 9 such as IC chips are accommodated in the recessed portions 8. That is, the recessed portions 8 have heretofore been formed by firing by using a ceramic green sheet having gaps or by punching by using a metal mold accompanied by such problems as defective lamination or deformation of the board. The above-mentioned problem, however, can be solved by forming the recessed portions 8 by utilizing the thermally extinguishing pattern.

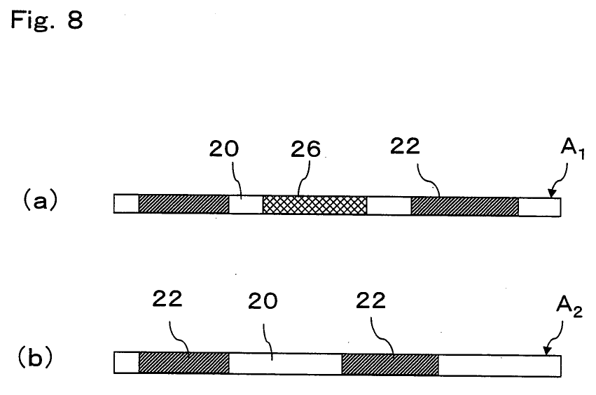

To form the multi-layer circuit board having the above circuit structure, there are used, as shown in FIG. 8, a circuit-parts sheet A₁ having the circuit-forming pattern 22 (conductor pattern) that serves as a conductor pattern and a thermally extinguishing pattern 26 for forming a recessed portion 8 formed in the ceramic sheet 20 (FIG. 8(a)), and a circuit-parts sheet A₂ having the conductor pattern 22 only formed in the ceramic sheet 20 (FIG. 8(b)). Depending upon the circuit structure, further, the above-mentioned functional pattern may be formed in the ceramic sheets 20 of the circuit-parts sheets A₁ and A₂.

The above-mentioned circuit-parts sheet having the thermally extinguishing pattern 26 can be formed in the same manner as the circuit-forming pattern 22 by using a resin paste for forming the thermally extinguishing pattern. These patterns 22 and 26 are formed on the carrier film 10 through the steps illustrated in FIGS. 2(a) to 2(e) above. In this circuit-parts sheet, too, the thermally extinguishing pattern 26 is formed in a thickness same as the thickness of the conductor pattern 22 to suppress the step relative to the ceramic sheet 20. By using the above circuit-parts sheet, further, there can be produced a multi-layer circuit board having the structure illustrated in FIG. 7. That is, the thermally extinguishing pattern 26 disintegrates and extinguishes at the time of firing.

In the above-mentioned embodiment, the thermally extinguishing pattern 26 is formed by using a paste of a thermally disintegrating resin. There is no particular limitation on the thermally disintegrating resin so far as it disintegrates at a firing temperature. From the standpoint of handing at the time of production, thermally disintegrating property and resistance against the developing solution, it is desired to use a cellulose resin such as ethyl cellulose, an acrylate resin such as butyl acrylate or a methacrylate resin such as methyl methacrylate. The resin paste that is used is prepared by adding, to the above thermally disintegrating resin, solvents such as dibutyl phthalate, α-terpineol, butyl carbitol and 2,2,4-trimethyl-3,3-pentadiol monoisobutylate each in an amount of not larger than 10 mass %, and by homogeneously kneading the mixture by using a three-roller mill. As required, further, a photo-curable resin may be added to impart photo-curing property. The resin paste may transmit light or may not transmit light. That is, even when the thermally extinguishing pattern 26 transmits light, the photo-curable coating layer formed on the thermally extinguishing pattern 26 forms the uncured portion (dissolving portion) by adjusting the conditions for light-exposure.

Upon forming the recessed portion 8 by using the light-nontransmitting thermally extinguishing pattern 26 as described above, there is no need of forming a gap in the unfired sheet for forming the recessed portion 8, and no machining such as punching is required either, effectively preventing defective lamination or deformation of the board.

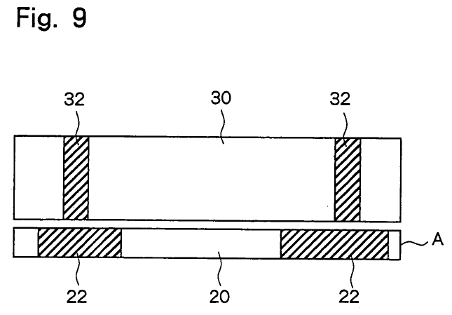

The present invention forms the multi-layer circuit board by using the circuit-parts sheet comprising the ceramic sheet in which the circuit-forming pattern is secured. It is, however, also allowable to produce the multi-layer circuit board by laminating the circuit-parts sheet on a ceramic green sheet formed by the conventional green sheet method. That is, as shown in FIG. 9, a ceramic green sheet 30 is overlapped on the circuit-parts sheet A comprising the ceramic sheet 20 having the circuit-forming pattern 22, and a laminate is formed by the same method as the one described above and is fired to fabricate a multi-layer circuit board. Here, the ceramic green sheet 30 is made of the same ceramic material as the ceramic sheet 20 except that it is not blended with the photo-curable component. The ceramic green sheet 30 has a thickness (usually, about 50 to about 200 μm) which is considerably larger than that of the ceramic sheet 20. It is further desired that the ceramic green sheet 30 is used as an insulating layer for forming via-conductors 32 by filling the through holes formed by punching or by laser working with a conducting paste, desirably without having a plane conductor layer. That is, if a plane conductor layer is formed on the ceramic green sheet, the level-difference is formed on the surface, whereby delamination occurs and the effect of the invention is halved. By using the ceramic green sheet 30 as an insulating layer for forming the via-conductors, at least the occurrence of delamination is prevented. FIG. 9 illustrates a lamination of one circuit-parts sheet A and one ceramic green sheet 30. Usually, however, the circuit-parts sheets A and the ceramic green sheets 30 are used in a plural number of layers.

### EXAMPLES

In the following Examples, there were used the following conducting paste and the photo-curable slurries A and B.

Conducting Paste:

To 100 parts by mass of an Ag powder, there were added 0.5 parts by mass of a barium borosilicate glass powder, 3 parts by mass of an ethyl cellulose, and 10 parts by mass of a 2,2,4-trimethyl-3,3-pentadiol monoisobutylate (organic solvent). The mixture was mixed together by using a three-roll mill to prepare a conducting paste.

Photo-Curable Slurry A:

100 Parts by mass of a ceramic starting powder, 8 parts by mass of a photo-curable monomer (polyoxyethylated trimethylolpropane triacrylate), 35 parts by mass of an organic binder (alkyl methacrylate) and 3 parts by mass of a plasticizer were mixed into an organic solvent (ethylcarbitol acetate), and the mixture was kneaded by using a ball mill. The ceramic starting powder was obtained by adding boron in an amount of 10 parts by mass (calculated as B₂O₃) and lithium in an amount of 5 parts by mass (calculated as LiCO₃) to 100 parts by mass of the chief component expressed by 0.95 mol MgTiO_{30.0.05} mol CaTiO₃.

Photo-Curable Slurry B:

A photo-curable slurry B was prepared in the same manner as the photo-curable slurry A but using, as a ceramic starting powder, 82 mass % of a glass powder of SiO₂—Al₂O₃—MgO—BaO—B₂O₃, and 18 mass % of a glass ceramic material (dielectric constant capacitance of 6.5) comprising an SiO₂ filler.

### Example 1

First, a conductor pattern that serves as a terminal electrode having a thickness of 20 μm was formed on a light-transmitting carrier film of PET (polyethylene terephthalate) having a thickness of 100 μm by printing the conducting paste by a screen-printing method.

Next, the photo-curable slurry A was applied onto the conductor pattern by a doctor blade method and was dried to form a photo-curable ceramic coating layer having a thickness after drying of 28 μm on a place where there was no conductor pattern.

Next, the carrier film was irradiated with light from a light source of a super-high pressure mercury lamp (illumination of 30 mW/cm²) for two seconds from the back surface side of the carrier film (from a distance of 50 cm). Then, by using a triethanolamine aqueous solution having a diluted concentration of 2.5%, the spray developing was conducted for 30 seconds. After the developing, the photo-curable ceramic coating layer was washed with pure water and was dried.

Upon photo-curing the photo-curable ceramic coating layer, the dissolving portion on the conductor pattern was removed by developing, the surface of the conductor pattern was exposed and, as a result, there was obtained a circuit-parts sheet having a conductor pattern (electrode layer) of a thickness of 20 μm secured in the cured ceramic sheet having a thickness of 20 μm. The developed surface of the cured ceramic sheet possessed a roughness Rmax of 2.2 μm.

There were prepared a total of 50 circuit-parts sheets having conductor patterns for internal wiring conductor layers, surface wiring conductor layers and via-conductors in the same manner but changing the shape of the conductor patterns.

The carrier films were peeled off from the thus produced circuit-parts sheets. The circuit-parts sheets were then brought into position successively, and were laminated. Between the circuit parts facing each other, the surface of the one circuit-parts sheet on where the cured ceramic sheet was laminated was selected to be the rough surface. Then, by using a pressing machine, the laminate was press-adhered with a pressing pressure of one ton at a temperature of 60° C. for 5 minutes.

Thereafter, the laminate was subjected to the binder-removing treatment in the atmosphere at 300° C. for 4 hours and was, then, fired in the atmosphere at 900° C. for 6 hours to fabricate the multi-layer circuit substrate.

The obtained multi-layer circuit board possessed quite no level-difference that stems from the thickness of the conductor pattern itself, and there occurred no delamination among the insulating layers, either. In order to connect the plane conductor pattern layers, further, a via-conductor was formed by laminating three or more conductor pattern layers in the vertical direction. However, there was quite no problem in the electric connection in the circuit which included the via-conductor. The occurrence of cavities in the conductor patterns was not at all recognized, either.

### Example 2

There were prepared a total of 70 circuit-parts sheets having conductor patterns for electrodes, internal wiring conductor layers, surface wiring conductor layers and via-conductors in the same manner as in Example 1, and were used in a state of being provided with the carrier films.

On the circuit-parts sheet for electrode, first, the circuit-parts sheet for via-conductor was overlapped while bringing them in position, such that the circuit-parts sheets were faced to each other.

Then, by using a pressing machine, the pressing was conducted with a pressing pressure of one ton at a temperature of 60° C. for 1 minute to press-adhere the circuit-parts sheet for electrode and the circuit-parts sheet for via-conductor. Then, the carrier film was peeled off from the circuit-parts sheet for via-conductor.

Thereafter, another circuit-parts sheet for via-conductor, circuit-parts sheet for internal wiring conductor layer and circuit-parts sheet for surface wiring conductor layer were overlapped while bringing them into position, and were successively press-adhered by using a pressing machine, and the films were peeled off to prepare a laminate.

Then, the laminate was subjected to the binder-removing treatment in the atmosphere at 300° C. for 4 hours and was, then, fired in the atmosphere at 900° C. for 6 hours to fabricate the multi-layer circuit substrate.

The obtained multi-layer circuit board possessed quite no level-difference that stems from the thickness of the conductor pattern itself, and there occurred no delamination among the insulating layers, either. In order to connect the plane conductor patterns, further, a via-conductor was formed by laminating three or more conductor pattern layers in the vertical direction. However, there was quite no problem in the electric connection in the circuit which included the via-conductor. The occurrence of cavities in the conductor patterns was not at all recognized, either.

### Example 3

As a material for forming a circuit pattern, there was used a copper foil having a thickness of 20 μm (one surface was a mat surface with a surface roughness Rz of 5 μm and the other surface was a shiny surface with a surface roughness Rz of 0.8 μm).

The above copper foil was stuck onto a PET film having a thickness of 100 μm such that the shiny surface was on the PET film side. Next, a circuit pattern for surface layer having a minimum wire width of 25 μm was formed by photo-etching.

Further, the above copper foil was stuck onto the PET film such that the mat surface was on the PET side. Then, there were formed, by photo-etching, a conductor pattern having a via-conductor of a diameter of 100 μm and a circuit pattern for internal layer. The circuit pattern for internal layer was subjected to a roughening treatment, so that the shiny surface exposed on the front surface possessed a roughness Rz of not smaller than 2 μm.

The PET films on which the circuit patterns were formed as described above were subjected to the application of the photo-curable slurry A, drying, exposure to light and developing in the same manner as in Example 1 to prepare circuit-parts sheets having a conductor pattern of a thickness of 20 μm and a photo-cured ceramic sheet of a thickness of 20 μm formed integrally together. There were thus prepared a total of 50 circuit-parts sheets having conductor patterns for internal wiring conductor layers, surface wiring conductor layers and via-conductors.

The carrier films were peeled off from the thus prepared circuit-parts sheets. The circuit-parts sheets were successively brought into position and were laminated. The laminate was press-adhered and fired to prepare a multi-layer circuit board like in Example 1.

The obtained multi-layer circuit board possessed quite no level-difference that stems from the thickness of the conductor pattern itself, and there occurred no delamination among the insulating layers, either. In order to connect the plane conductor pattern layers, further, a via-conductor was formed by laminating three or more conductor patterns of metal foils in the vertical direction. However, there was quite no problem in the electric connection in the circuit which included the via-conductor.

### Example 4

A conductor pattern that serves as a wiring conductor layer having a thickness of 25 μm was formed on a PET film having a thickness of 100 μm in the same manner as in Example 1.

Then, a dielectric paste was applied onto the PET film to form a functional pattern that serves as a layer of a high dielectric constant having a thickness of 25 um together with the conductor pattern. The composition of the dielectric paste was as described below.

Composition of the dielectric paste:

A ceramic material (dielectric constant capacitance of 18.4) was obtained by adding 10 parts by mass of boron (calculated as B₂O₃) and 5 parts by mass of lithium (calculated as LiCO₃) to 100 parts by mass of the main component expressed by 0.95 mol MgTiO₃-0.05 mol CaTiO₃. To 100 parts by mass of the ceramic material, there were added 2 parts by mass of an ethyl cellulose and 10 parts by mass of a 2,2,4-trimethyl-3,3-pentadiol monoisobutylate, and the mixture was homogeneously kneaded by using a three-roll mill to prepare a dielectric paste.

Next, the photo-curable slurry B was applied onto the conductor pattern and onto the functional pattern by a doctor blade method, and was dried to form a photo-curable ceramic coating layer having a thickness after drying of 29 μm on a place where there was no conductor pattern or functional pattern.

Next, the photo-curable ceramic coating layer was exposed to light and developed in quite the same manner as in Example 1 to obtain a circuit-parts sheet having a conductor pattern of a thickness of 25 μm and a functional pattern of a thickness of 25 μm secured in the cured ceramic sheet of a thickness of 25 μm.

There were further prepared circuit-parts sheets for internal wiring conductor layers, surface wiring conductor layers and via-conductors in the same manner as described above but without forming the functional pattern.

By using a total of 50 pieces of the circuit-parts sheets prepared as described above, a laminate was prepared in quite the same manner as in Example 1, and a multi-layer circuit board was fabricated in quite the same manner as in Example 1. (After firing, the thickness of the dielectric layer and the thickness of the conducting layer were 20 μm.

The obtained multi-layer circuit board possessed quite no level-difference that stems from the thickness of the conductor pattern or the functional pattern, and there occurred no delamination among the insulating layers, either. In order to connect the plane conductor pattern layers, further, a via-conductor was formed by laminating three or more conductor pattern layers in the vertical direction. However, there was quite no problem in the electric connection in the circuit which included the via-conductor. The occurrence of cavities in the conductor patterns and in the functional patterns was not at all recognized, either. Further, an electrostatic capacity of 5 pF was obtained between the conductor patterns (electrodes) formed on and under the functional pattern (dielectric layer).

### Example 5

A conductor pattern that serves as a wiring conductor layer having a thickness of 20 μm was formed on a PET film having a thickness of 100 μm in the same manner as in Example 1.

Then, a resin paste obtained by adding 2 mass % of a butyl cellosolve as a solvent to the acrylic resin was applied onto the PET film maintaining a thickness of 20 μm by the screen-printing method to form a thermally extinguishing pattern, followed by drying in an oven heated at 80° C. for 15 minutes to form a resin layer.

Next, the photo-curable slurry A was applied onto the conductor pattern and onto the thermally extinguishing pattern by a doctor blade method and was dried to form a photo-curable ceramic coating layer having a thickness after drying of 24 μm on a place where there were none of these patterns.

Next, the photo-curable ceramic coating layer was exposed to light and developed in quite the same manner as in Example 1 to obtain a circuit-parts sheet having the conductor pattern of a thickness of 20 μm and the thermally extinguishing pattern of a thickness of 20 μm secured in the cured ceramic sheet of a thickness of 20 μm.

There were further prepared circuit-parts sheets for internal wiring conductor layers, surface wiring conductor layers and via-conductors in the same manner as described above but without forming the functional pattern.

By using a total of 50 pieces of the circuit-parts sheets prepared as described above, a laminate was prepared and fired in quite the same manner as in Example 1, and a multi-layer circuit board was fabricated in quite the same manner as in Example 1. In the laminate, the upper 15 layers were the circuit-parts sheets having the thermally extinguishing patterns.

The obtained multi-layer circuit board possessed quite no level-difference that stems from the thickness of the conductor layer itself, and there occurred no delamination among the insulating layers, either. In order to connect the plane conductor layers, further, a via-conductor was formed by laminating three or more conductor layers in the vertical direction. However, there was quite no problem in the electric connection in the circuit which included the via-conductor. The occurrence of cavities in the conductor layers was not at all recognized, either.

After the firing, the thermally extinguishing patterns which were the thermally disintegrating resin layers were completely removed, and recessed portions were formed. The flatness in the recessed portion was measured by a probe method to be 0.8 μm. Thus, the bottom surface exhibited a high degree of flatness, from which it was confirmed that the substrate had not been almost deformed. Further, the recessed portion was cut and the laminated portion just under the recessed portion was observed. As a result, the interlayer peeling was not recognized at all.

1. A method of producing a circuit-parts sheet having a structure in which a circuit-forming pattern having light-nontransmitting property is secured in a photo-cured ceramic sheet and is exposed on both surfaces of said photo-cured ceramic sheet, comprising the steps of:
(a) forming the circuit-forming pattern having light-nontransmitting property on a surface of a carrier film having light-transmitting property;
(b) forming a photo-curable ceramic coating layer having a thickness not smaller than the thickness of said circuit-forming pattern and in which said circuit-forming pattern is buried, by applying a photo-curable slurry containing an electrically insulating ceramic material on the surface of the carrier film on which said circuit-forming pattern is formed;
(c) forming a photo-cured ceramic sheet by photo-curing said photo-curable ceramic coating layer by the irradiation with light from the back surface of said carrier film;
(d) removing uncured portions of said photo-curable ceramic coating layer by using a developing solution; and
(e) peeling off said carrier film.

2. A method of producing a circuit-parts sheet according to claim 1, wherein both said photo-cured ceramic sheet and said circuit-forming pattern have thicknesses of not larger than 50 μm, and a difference in the thickness between said photo-cured ceramic sheet and the circuit-forming pattern is not larger than 5 μm.

3. A method of producing a circuit-parts sheet according to claim 1, wherein said circuit-forming pattern is formed by using at least either one of an electrically conducting material or an electrically insulating ceramic material.

4. A method of producing a circuit-parts sheet according to claim 3, wherein said electrically conducting material contains a metal powder and an organic binder.

5. A method of producing a circuit-parts sheet according to claim 3, wherein said electrically conducting material is a metal foil.

6. A method of producing a circuit-parts sheet according to claim 1, wherein said circuit-forming pattern and a thermally extinguishing pattern are so formed in said step (a) that said circuit-forming pattern and said thermally extinguishing pattern will not be overlapped one upon the other, and the photo-curable ceramic coating layer is so formed in said step (b) that said circuit-forming pattern and said thermally extinguishing pattern are buried therein.

7. A method of producing a circuit-parts sheet according to claim 6, wherein said thermally extinguishing pattern is formed by using a thermally disintegrating resin composition.

8. A method of producing a circuit-parts sheet according to claim 1, wherein one surface of said photo-cured ceramic sheet has a maximum surface roughness Rmax (JIS B 0601) of not smaller than 1 μm.

9. A method of producing a multi-layer circuit board comprising the steps of:
(f) laminating a plurality of pieces of the circuit-parts sheets obtained by the production method of claim 1; and
(g) firing the laminate thereof.

10. A method of producing a multi-layer circuit board by preparing a circuit-parts sheet which comprises a photo-cured ceramic sheet and a circuit-forming pattern secured to said sheet and having light-transmitting property through the steps (a) to (d) described below and, then, conducting the steps (h) to (k) described below:
(a) forming the circuit-forming pattern having light-nontransmitting property on a surface of a carrier film having light-transmitting property;
(b) forming a photo-curable ceramic coating layer having a thickness not smaller than the thickness of said circuit-forming pattern and in which said circuit-forming pattern is buried, by applying a photo-curable slurry containing an electrically insulating ceramic material on the surface of the carrier film on which said circuit-forming pattern is formed;
(c) forming a photo-cured ceramic sheet by photo-curing said photo-curable ceramic coating layer by the irradiation with light from the back surface of said carrier film;
(d) removing uncured portions of said photo-curable ceramic coating layer by using a developing solution;
(h) preparing a plurality of pieces of the circuit-parts sheets with the carrier film obtained through the step (d);
(i) laminating another circuit-parts sheet with the carrier film on one circuit-parts sheet with the carrier film in a manner that the circuit-parts sheets are opposed to each other, and peeling off the carrier film from the other circuit-parts sheet;
(j) fabricating a laminate having a plurality of pieces of the circuit-parts sheets by repeating the step (i); and
(k) peeling off the carrier film from said one circuit-parts sheet of the obtained laminate, followed by firing.

11. A method of producing a multi-layer circuit board according to claim 10, wherein both said photo-cured ceramic sheet and said circuit-forming pattern have thicknesses of not larger than 50 μm, and a difference in the thickness between said photo-cured ceramic sheet and the circuit-forming pattern is not larger than 5 μm.

12. A method of producing a multi-layer circuit board according to claim 10, wherein said circuit-forming pattern is formed by using at least either one of an electrically conducting material or an electrically insulating ceramic material.

13. A method of producing a multi-layer circuit board according to claim 12, wherein said electrically conducting material contains a metal powder and an organic binder.

14. A method of producing a multi-layer circuit board according to claim 12, wherein said electrically conducting material is a metal foil.

15. A method of producing a multi-layer circuit board according to claim 10, wherein said circuit-forming pattern and a thermally extinguishing pattern are so formed in said step (a) that said circuit-forming pattern and said thermally extinguishing pattern will not be overlapped one upon the other, and the photo-curable ceramic coating layer is so formed in said step (b) that said circuit-forming pattern and said thermally extinguishing pattern are buried therein.

16. A method of producing a multi-layer circuit board according to claim 15, wherein said thermally extinguishing pattern is formed by using a thermally disintegrating resin composition.

17. A method of producing a multi-layer circuit board according to claim 10, wherein one surface of said cured ceramic sheet has a maximum surface roughness Rmax (JIS B 0601) of not smaller than 1 μm, and the laminate is so formed that the roughened surfaces are opposed to each other.

18. A method of producing a multi-layer circuit board by preparing a circuit-parts sheet which comprises a photo-cured ceramic sheet and a circuit-forming pattern secured to said sheet and is held on a surface of a carrier film having light-transmitting property through the steps (a) to (d) described below and, then, laminating a ceramic green sheet having through-holes filled with a conducting paste on said circuit-parts sheet, and peeling off the carrier film from the obtained laminate, followed by firing:
(a) forming the circuit-forming pattern having light-nontransmitting property on the surface of a carrier film having light-transmitting property;
(b) forming a photo-curable ceramic coating layer having a thickness not smaller than the thickness of said circuit-forming pattern and in which said circuit-forming pattern is buried, by applying a photo-curable slurry containing an electrically insulating ceramic material on the surface of the carrier film on which said circuit-forming pattern is formed;
(c) forming a photo-cured ceramic sheet by photo-curing said photo-curable ceramic coating layer by the irradiation with light from the back surface of said carrier film; and
(d) removing uncured portions of said photo-curable ceramic coating layer by using a developing solution.
